(19) United States
(12) Patent Application Publication
(10) Pub. No.: US 2016/0162253 A1
(43) Pub. Date: Jun. 9, 2016

(54) SYSTEM AND METHOD FOR PLAYING MUSIC

(71) Applicant: Jun-Wei Su, Taichung City (TW)

(72) Inventor: Jun-Wei Su, Taichung City (TW)

(21) Appl. No.: 14/823,999

(22) Filed: Aug. 11, 2015

(30) Foreign Application Priority Data
Dec. 9, 2014 (TW) 103142920

(51) Int. Cl. G06F 3/16; G06F 3/0488; G06F 3/0484

(52) U.S. Cl. CPC G06F 3/165; G06F 3/04847; G06F 3/0488

(57) ABSTRACT

A music player system is used in a mobile device having a touch panel. The music player system includes a reader unit, an identifying and sorting unit, a labeling unit, an operation interface and an execution unit. The reader unit reads music files. The identifying and sorting unit identifies and sorts the music files according to their tempos, issue dates and pitches. The labeling unit gives each music file a tempo label value, a time label value and a pitch label value according to results of the identifying and sorting conducted by the identifying and sorting unit. The operation interface is shown on the touch panel and receives a command from a user. The execution unit executes a procedure according to the command. The sequences of tempos, pitches and issue dates are set based on the user's preference. The music files are played according to the user's preference.

### BACKGROUND OF INVENTION

1. Field of Invention

The present invention relates to a system for playing music and, more particularly, to a system for playing music in a smart mobile device according to preferences set by a user.

2. Related Prior Art

Smart mobile devices are equipped with large memories and hence can be used as carriers for a lot of music files to satisfy music lovers' need by allowing them to use the smart mobile devices to play music whenever and wherever they want.

A typical player software program executed in a smart mobile device builds a list of the titles of music files according to a sequence of the titles or a sequence of time in which the music files are downloaded. The list is shown on a touch panel of the smart mobile device. A user operates the touch panel in a scrolling manner to review the title list and select from the title list a title of a music file to be played. The player software program receives the user's command and plays a music file according to the selected title. Then, the player software program automatically plays music files of which the titles follow the selected title on the title list.

A problem with the operation of the typical player software program lies in the operation in the scrolling manner. It is difficult to select a title from the list by scrolling if the number of the music files is large and the user is not sure of or does not know the title of a music file.

Another problem with the operation of the typical player software lies in lack of sorting. The music files are not sorted into lyric, rock and roll, heavy metal, up-tempo, slow, and etc. No matter the music files are played sequentially according to the list or in random, the music files are not played according to their types. Hence, a lyric song can be followed by a rock and roll song, and a piece of classic music can follow the rock and roll song.

Some situational player software programs can solve the foregoing problems. These situational player software programs sort the music files into lyric, rock and roll, soft music, classic, etc. according to their tempos, styles, issue dates, singers, composers/song writers, etc. Thus, there are provided situational lists each presenting a type of music. The situational lists are shown on the touch panel of a smart mobile device. The user operates the touch panel to select one situational list. Then, the player software program plays the music files on the selected situational list in random or sequence. The situational player software programs are not without any problem. The music files could still be played in a messy manner if the number of the situational lists is very small. On the other hand, if the number of the situational lists is very large, one situational list could be like another situational list, and a music file could be listed on two or more situational lists. For example, it is difficult for an ordinary user to tell soft music from lyric music, lyric songs from romantic songs, living-room music from cafémusic, nature music from healing music, rock and roll from jazz, or heavy metal from rock and roll.

Furthermore, the sizes of the screens of the smart mobile devices are limited in consideration of portability. With a long list or a large number of situational lists shown on a small screen, the user reviews the titles on the long list or the numerous situational lists on the screen by scrolling. The operation requires concentration and precise maneuvering. It is possible when the user stays still, not when the user moves about such as during jogs, walks, drives and cooks. Hence, the user often has to stop what he or she is doing to operate the smart mobile device to select a music file.

Moreover, the typical player software program and the situational player software program both fail to allow a user to quickly build a list of music files according to his or her preferences at any moment.

The present invention is therefore intended to obviate or at least alleviate the problems encountered in the prior art.

### SUMMARY OF INVENTION

It is the primary objective of the present invention to provide a music player system that enables a user to select, based on his or her preferences, at least one music file from a large number of music files and play the selected music file in a smart mobile device that includes a touch panel.

To achieve the foregoing objective, the music player system includes a reader unit, an identifying and sorting unit, a labeling unit, an operation interface and an execution unit.

The reader unit reads all music files in a music data folder in a storage medium of the smart mobile device. Each of the music files includes a title label.

The identifying and sorting unit is used to identify, sort and sequence all of the music files read by the reader unit according to their tempos, issue dates and pitches.

The labeling unit gives each music file a tempo label value, a time label value and a pitch label value according to results of the identifying, sorting and sequencing conducted by the identifying and sorting unit. The tempo label value, the time label value and the pitch label value are written in the title label of the music file.

The operation interface is shown on the touch panel and receives a touch on the touch panel by the user and the coordinate of the touch. The touch and at least one corresponding coordinate together constitute a command. The command represents the user's preference. The operation interface provides a first mode, a second mode and a third mode. The first mode of the operation interface includes a tempo axis and a time axis. The tempo axis perpendicularly intersects the time axis at a common origin. The second mode of the operation interface includes a pitch axis and a time axis. The pitch axis perpendicularly intersects the time axis at a common origin. The third mode of the operation interface includes a tempo axis and a pitch axis. The tempo axis perpendicularly intersects the pitch axis at a common origin. The tempo axis includes two ends respectively representing slow tempo and quick tempo. The operation interface prompts the user to touch the touch panel to select a desired situation to set his or her preference for music.

The execution unit builds a playlist according to the command and plays the music files according to the playlist. The step for building a playlist is done by a function to calculate a relational value of each music file. The smaller the difference is between the relational values of two music files, the more similar the music files are. The relational value is written in the title label of each music file. The execution unit compares the relational value with a threshold value, and lists a music file on a playlist if its relational value is smaller than or equal to the threshold value. Then, the execution unit initiates a player of the smart mobile device to play the music files on the playlist. That is, the execution unit plays the music files based on the preference set by the user.

The command can be a clicking command, a scrolling command, a threshold value-changing command, a list-changing command, a locking command or a cancelling command. On receiving the clicking command or the scrolling command, the execution unit deletes a previous playlist, builds a playlist and plays the music files. On receiving the threshold value-changing command, the execution unit changes the threshold value. On receiving the list-changing command, the execution unit stops playing the music files and deletes the playlist. On receiving the locking command, the execution unit repeats the play of the music file for at least once. On receiving the cancelling command, the execution unit cancels the locking command.

An advantage of the present invention is to allow the user to set his or her preference for music files according to their tempos, issue time and pitches and build a playlist according to his or her preference and play the music files on the playlist.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a schematic view of a first mode of an operation interface of a music player system according to the preferred embodiment of the present invention;

FIG. 2 is a schematic view of a second mode of the operation interface of the music player system according to the preferred embodiment of the present invention; and

FIG. 3 is a schematic view of a third mode of the operation interface of the music player system according to the preferred embodiment of the present invention.

### DETAILED DESCRIPTION OF PREFERRED EMBODIMENT

A music player system is used in a smart mobile device that includes a touch panel. The music player system includes a reader unit, an identifying and sorting unit, a labeling unit, an operation interface and an execution unit according to the preferred embodiment of the present invention.

The reader unit is used to read music files. The identifying and sorting unit is used to identify, sort and sequence all of the music files read by the reader unit. The labeling unit is used to provide each of the music files with a first label value C1 and a second label value C2 according to results of the identifying and sorting done by the identifying and sorting unit. The first label value C1 and the second label value C2 are written in the music file. The operation interface is shown on the touch panel and receives a command from a user. The execution unit executes procedures according to the command received by the operation interface.

In detail, the reader unit reads all music files stored in a music data folder in a storage medium of the smart mobile device. Each of the music files includes a title label such as ID3Tags of a MP3 file. The title label includes data of the title, the singer, the album, the issue date, the type, the style, notes, etc.

The identifying and sorting unit executes a tempo-identifying software program to determine the tempo of each of the music files. The identifying and sorting unit executes a pitch-identifying software program to determine the pitch of each of the music files. The identifying and sorting unit executes an issue date-identifying software program to identify the issue date written in the title label of each of the music files.

The labeling unit adds a tempo label value R, a time label value T and a pitch label value Q into the title label of each of the music files according to the results of the identifying and sorting conducted by the identifying and sorting unit. The first label value C1 can be the tempo label value R, the time label value T or the pitch label value Q. The second label value C2 can be the tempo label value R, the time label value T or the pitch label value Q. However, the first label value C1 is not identical to the second label value C2.

There are various methods for providing the tempo label value R. Two methods will be described for example, not for limiting the scope of the present invention.

A method for providing relative tempo labels will be described first. For example, the music file with the slowest tempo receives a tempo label value R of −N/2. The music file with the quickest tempo receives a tempo label value R of N/2. N is the total number of the music files in the music data folder. The other music files receive tempo label values R of (−N/2)+1 to (N/2)−1 in a sequence of the tempos. If N is an odd number, the integer part is taken as the tempo label value R while the decimal part is discarded. If N is an even number, “0” is not used as a tempo label value. The larger the tempo label value R is, the faster the tempo is. For example, the total number of the music files in the music data folder is assumed to be 2000. The music file with the slowest tempo receives a tempo label value R of −1000. The music file with the quickest tempo receives a tempo label value R of 1000. The other music files receive tempo label values R of −999 to 999, excluding 0. Numeric ranges can be used for groups of the music files with similar tempos. For example, a range of (−N/2)+1 to (N/2)+100 represents a first group of slow tempo, and each music file in this range receives a label in the first group of slow tempo. A range of (−N/2)+101 to (N/2)+200 represents a second group of slow tempo, and each music file in this range receives a label in the second group of slow tempo. The second group of slow tempo is quicker than the first group of slow tempo. Similarly, the other music files receive proper labels in proper groups. When there is a new music file, it can quickly receive a proper tempo label value. However, if there are many new music files, another round of identifying and labeling can be conducted.

Alternatively, the music files can be labeled according to an absolute tempo method. A pleasant music tempo is in the range of 900 to 20 beats every minute. The main themes of all of the music files are identified, and an actual average tempo label value Rx is given. Moreover, the music file with the slowest tempo receives a tempo label value R of −N. The music file with the quickest tempo receives a tempo label value R of N. N is a constant of 1000. In a sequence of the tempos, the other music files receive tempo label values in an arithmetic series. The larger the tempo label value is, the quicker the tempo is. For example, the total number of the music files in the music data folder is assumed to be 5000. The music file with the slowest tempo receives a tempo label value R of −1000. The music file with the quickest tempo receives a tempo label value R of 1000. The other music files receive tempo label values R of −999 to 999 in a sequence of the tempos. Numeric ranges can be used for groups of the music files with similar tempos. For example, a range of −N+1 to −N+100 represents a first group of slow tempo, and each music file in this range receives a label in the first group of slow tempo. A range of −N+101 to −N+200 represents a second group of slow tempo, and each music file in this range receives a label in the second group of slow tempo. The second group of slow tempo is quicker than the first group of slow tempo. Similarly, the other music files receive proper labels in proper groups. When there is a new music file, it can quickly receive a proper tempo label.

There are various methods for giving the pitch label value Q. A method will be given for example, not for limiting the scope of the present invention. The music file with the lowest main theme pitch receives a pitch label value Q of −N/2. The music file with the highest main theme pitch receives a pitch label value Q of N/2. N is the total number of the music files in the music data folder. The other music files receive pitch labels Q of (−N/2)+1 to (N/2)−1 in a sequence of the pitches. If N is an odd number, the integer part is taken as the pitch label value Q while the decimal part is discarded. If N is an even number, “0” is not used as a pitch label value. The higher the pitch label value Q is, the higher the pitch is. For example, the total number of the music files in the music data folder is assumed to be 2000. The music file with the lowest main theme pitch receives a pitch label value Q of −1000. The music file with the highest main theme pitch receives a pitch label value Q of 1000. The other music files receive pitch label values of −999 to 999. Numeric ranges can be used for groups of the music files with similar pitches. For example, a range of (−N/2)+1 to (−N/2)+100 represents a first group of low pitch, and each music file in this range receives a label in the first group of low pitch. A range of (−N/2)+101 to (−N/2)+200 represents a second group of low pitch, and each music file in this range receives a label in the second group of low pitch. The second group of low pitch is higher than the first group of low pitch. Similarly, the other music files receive proper labels in proper groups. When there is a new music file, it can quickly receive a proper pitch label.

There are various methods for giving the time label value T. A method will be given for example, not for limiting the scope of the present invention. The music file with the earliest issue date receives a time label value T of −M/2. The music file with the latest issue date receives a time label value T of M/2. M is the total number of the music files in the music data folder. The other music files receive time label values T of (−M/2)+1 to (M/2)−1. The larger the time label value T is, the later the issue date is. For example, the total number of the music files in the music data folder is assumed to be 2000. The music file with the earliest issue date receives a time label value T of −1000. The music file with the latest issue date receives a time label value T of 1000. The other music files receive time label values T of −999 to 999, excluding 0.

The operation interface selectively provides a first mode 101, a second mode 102 or a third mode 103, depending on the user's choice.

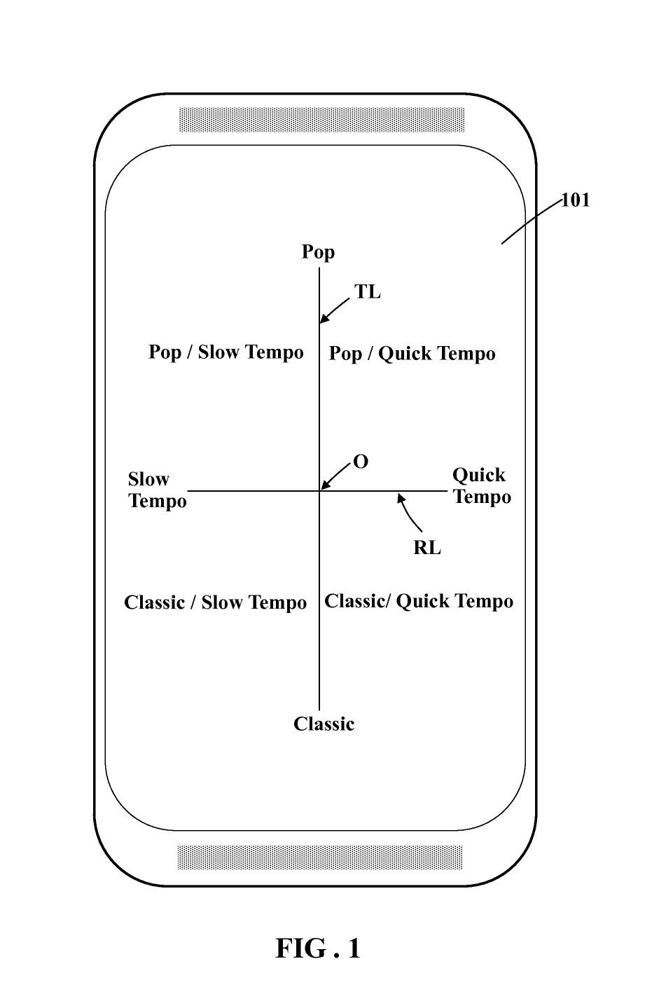

Referring to FIG. 1, the first mode 101 of the operation interface 10 includes a tempo axis RL perpendicularly intersecting a time axis TL at a common origin O. The tempo axis RL and the time axis TL can be shown on the touch panel, or not. Two senses of direction of the tempo axis RL respectively represent slow tempo and quick tempo. Two senses of direction of the time axis TL respectively represents pop (late issue dates) and classic (early issue dates). The tempo axis RL and the time axis TL constitute a coordinate system including four quadrants. Quadrant I represents pop/quick tempo. Quadrant II represents pop/slow tempo. Quadrant III represents classic/slow tempo. Quadrant IV represents classic/quick tempo.

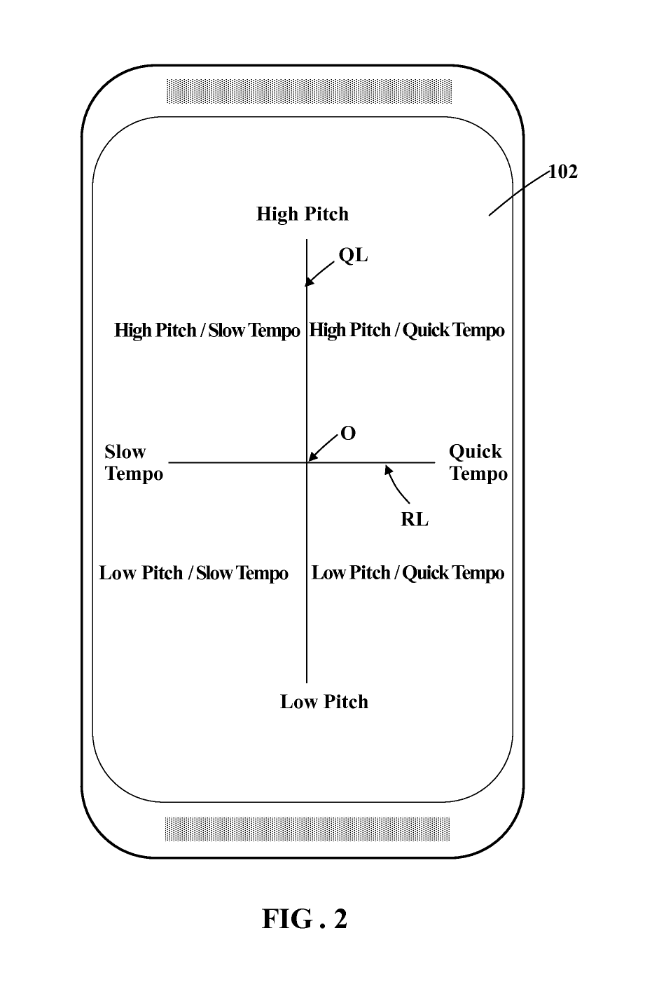

Referring to FIG. 2, the second mode 102 of the operation interface 10 includes a tempo axis RL perpendicularly intersecting a pitch axis QL at a common origin O. The tempo axis RL and the pitch axis QL can be shown on the touch panel, or not. Two senses of direction of the tempo axis RL respectively represent slow tempo and quick tempo. Two senses of direction of the pitch axis QL respectively represent high pitch and low pitch. The tempo axis RL and the pitch axis QL constitute a coordinate system including four quadrants. Quadrant I represents high pitch/quick tempo. Quadrant II represents high pitch/slow tempo. Quadrant III represents low pitch/slow tempo. Quadrant IV represents low pitch/quick tempo.

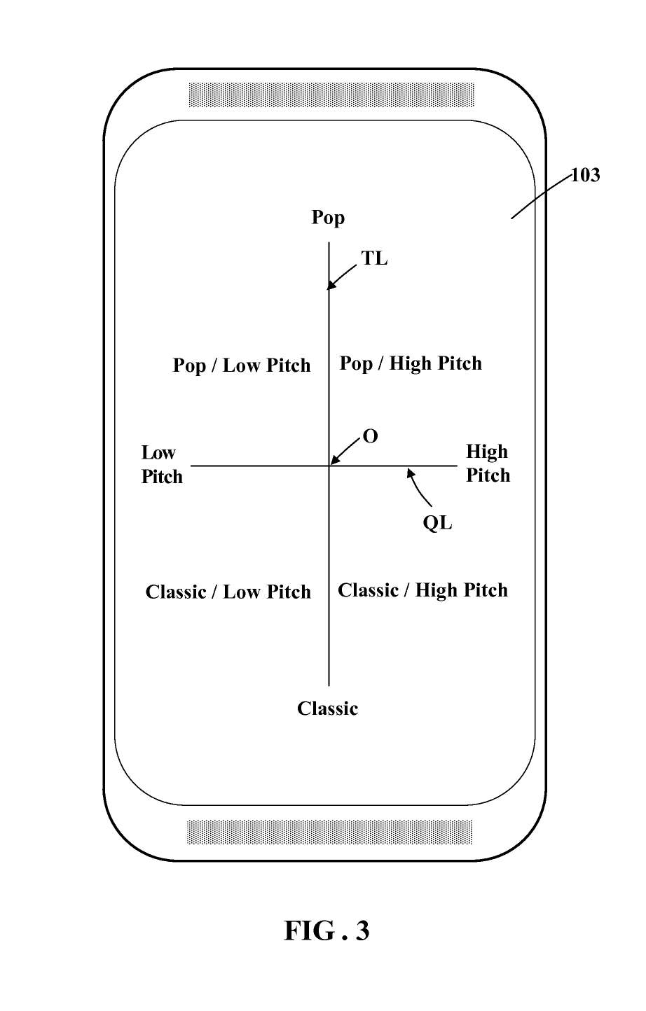

Referring to FIG. 3, the third mode 103 of the operation interface 10 includes a pitch axis QL perpendicularly intersecting a time axis TL at a common origin O. The time axis TL and the pitch axis QL can be shown on the touch panel, or not. Two senses of direction of the time axis TL respectively represent pop (late issue dates) and classic (early issue dates). Two senses of direction of the pitch axis QL respectively represent high pitch and low pitch. The time axis TL and the pitch axis QL constitute a coordinate system including four quadrants. Quadrant I represents pop/high pitch. Quadrant II represents pop/low pitch. Quadrant III represents classic/low pitch. Quadrant IV represents classic/high pitch.

The user operates the touch panel to select from the situations provided by the operation interface. The user's manner of operating the touch panel and at least one coordinate together constitute a command for the operation interface. The manner of operating the touch panel can be a single click, one-finger scrolling, two-finger scrolling, double clicks or a long touch (longer than 2 seconds).

A single click on the touch panel and a coordinate together constitute a clicking command. One-finger scrolling on the touch panel and the coordinates of a starting point and a final point together constitute a scrolling command. Two-finger scrolling on the touch panel and the coordinates of two starting points and two final points together constitute a threshold value-changing command for changing a threshold value. Double clicks on the touch panel regardless of the coordinate constitute a list-changing command. A long touch (longer than 2 seconds) regardless of the coordinate constitutes a locking command. Another long touch (longer than 2 seconds) regardless of the coordinate constitute an unlocking command.

On receiving the clicking command or the one-finger scrolling command, the execution unit builds a playlist and plays the music files on the playlist. On receiving the threshold value-changing command, the execution unit executes a threshold value-changing procedure. On receiving the list-changing command, the execution unit executes a stopping and playlist-deleting procedure. On receiving the locking command, the execution unit repeats the playing of the music file that is playing for at least once. On receiving the unlocking command, the execution unit cancels the locking command.

The procedure for building a playlist according to the clicking command includes four steps. At the first step, the coordinate (X, Y) of the single click is obtained.

At the second step, a relational value P is provided for each of the music files and written in the title label of each of the music files according to the following equation:

(X−C1)²+(Y−C2)²=P (1)

wherein (X, Y) is the coordinate of the single click on the touch panel, and C1 and C2 are respectively the first label value and the second label value. When the user uses the first mode 101 of the operation interface 10 to give the clicking command, the first label value is the tempo label value (C1=R), and the second label value is the time label value (C2=T). When the user uses the second mode 102 of the operation interface 10 to give the clicking command, the first label value is the tempo label value (C1=R), and the second label value is the pitch label value (C2=Q). When the user uses the third mode 103 of the operation interface 10 to give the clicking command, the first label value is the pitch label value (C1=Q), and the second label value is the time label value (C2=T). Take the tempo label value and the time label value for example, if the touch coordinate is (20, 30), the corresponding music file includes a tempo label value R of −1000 and a time label value T of −1000, and the relational value P is [20−(−1000)]²+[30−(−1000)]² =2,101,300. Similarly, the relational values P of the other music files can be calculated by this equation.

At the third step, the relational value P is compared with a threshold value F. A music file is included in a playlist if the relational value P thereof is smaller than or equal to the threshold value F (P F). For example, the threshold value F is 500000 if the total number of the music files is 2000. The threshold value F can be adjusted.

At the fourth step, the execution unit initiates the player of the smart mobile device to play the music files in random of in a sequence of the relational values P on the playlist, from the smallest to the largest.

A procedure for building a playlist according to a scrolling command includes five steps. At the first step, the coordinate (X1, Y1) of the starting point and the coordinate (X2, Y2) of the final point of the scrolling are obtained.

At the second step, the coordinate of a vector (X3, Y3) on the touch panel is calculated by the following equation:

(X2−X1, Y2−Y1)=(X3, Y3) (2)

At the third step, a relational value P is provided for each music file according to an equation as follows and written in the title label of the music file:

(X3−C1)²+(Y3−C2)²=P (3)

wherein (X3, Y3) represents the coordinate of the vector, and C1 and C2 are respectively the first label value and the second label value. When the user uses the first mode 101 of the operation interface 10 to give a clicking command, the first label value is the tempo label value (C1=R), and the second label value is time label value (C2=T). When the user uses the second mode 102 of the operation interface 10 to give a clicking command, the first label value is the tempo label value (C1=R), and the second label value is the pitch label value (C2=Q). When the user uses the third mode 103 of the operation interface 10 to give a clicking command, the first label value is the pitch label value (C1=Q), and the second label value is the time label value (C2=T). Take the tempo label value and the time label value for example, when the coordinate of the vector is (20, 30), the music file includes a tempo label value R of −1000 and a time label value T of −1000, and the relational value P thereof is [20−(−1000)²]+[30−(−1000)]²=2,101,300. Similarly, the relational values P of the other music files can be calculated.

At the fourth step, the relational value P is compared with a threshold value F. A music file is included in a playlist if the relational value P thereof is smaller than or equal to the threshold value F (P≦F). For example, the threshold value F is 500000 if the total number of the music files is 2000. The threshold value F can be adjusted.

At the fifth step, the execution unit initiates the player of the smart mobile device to play the music files in random or in a sequence of the relational values P on the playlist, from the smallest to the largest.

The procedure for changing the threshold value according to the threshold value-changing command includes three steps. At the first step, the coordinates of two starting points and two final points of the two-finger scrolling are obtained. The coordinate of the starting point of the first finger is (X01, Y01). The coordinate of the final point of the first finger is (X02, Y02). The coordinate of the starting point of the second finger is (X03, Y03). The coordinate of the final point of the second finger is (X04, Y04).

At the second step, a distance DN1 between the starting points of the first and second fingers and a distance DN2 between the final points of the first and second fingers are respectively calculated by two equations as follows:

(X01−X03)²+(Y01−Y03)²=DN1 (4)

(X02−X04)²+(Y02−Y04)²=DN2 (5)

At the third step, if DN1>DN2, the first and second fingers move towards each other, and the threshold value F is reduced. If DN1<DN2, the first and second fingers move away from each other, and the threshold value F is increased. The threshold value F can be reduced or increased according to or in proportion to the difference between DN1 and DN2. The threshold value F can be as small as 1 and as large as 2(A)², wherein A represents the total number of the music files. The smaller the threshold value F is, the closer the played music file is related to the selected situation.

Between the first and second steps of the threshold value-changing procedure or after the third step of the same, the playlist is cancelled. However, the clicking command or scrolling command is retained to facilitate building a playlist according to the command and playing the music file after changing the threshold value.

When the user downloads the music player system to his or her smart mobile device, the music player system executes a preceding procedure via the reader unit, identifying and sorting unit and the labeling unit. After the preceding procedure is completed, the music player system executes a playing procedure via the operation interface and the execution unit. As discussed above, the preceding procedure includes three steps. At the first step, the system reads all of the music files and their title labels in the music data folder of the storage medium of the smart mobile device.

At the second step, the system is used to identify, sort and sequence all of the music files.

At the third step, the system provides each music file with a first label value (C1) and a second label value (C2), and writes the first label value (C1) and the second label value (C2) in the title label of each music file.

When the preceding procedure is completed, the operation interface and execution unit of the system execute the clicking command or the scrolling command according to the preference set by the user.

In the playing procedure, the user can execute the clicking command, the scrolling command, the threshold value-changing command, the list-changing command, the locking command, and the unlocking command at any time.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A music player system for use in a mobile device that includes a touch panel, the music player system comprising:
a reader unit for reading all music files in a music data folder in a storage medium of the smart mobile device, each of the music files comprising a title label;
an identifying and sorting unit for identifying, sorting and sequencing all of the music files read by the reader unit;
a labeling unit for providing each of the music files with a first label value (C1) and a second label value (C2) and writing the first label value (C1) and the second label value (C2) in the title label of the music file according to results of the identifying, sorting and sequencing conducted by the identifying and sorting unit;
an operation interface shown on the touch panel to receive a command via the touch panel; and
an execution unit for building a playlist based on the command and playing the music files on the playlist, the execution unit having a threshold value (F) and building the playlist in a process comprising the steps of:
calculating a relational value (P) for each of the music files;
writing the relational value (P) in the title label of each of the music files;
comparing the relational value (P) of each of the music files with the threshold value (F) and including the music file on the playlist if the relational value (P) is smaller than or equal to the threshold value (F); and
initiating a player of the smart mobile device to play the music files on the playlist,
wherein when the command received is a clicking command provided by a single click and its coordinate on the touch panel, the relational value (P) for each of the music files is calculated by:
(X−C1)²+(Y−C2)²=P (1)
wherein X is the coordinate of the command on an X-axis of a coordinate system, Y is the coordinate of the command on a Y-axis of the coordinate system, C1 is the first label value, and C2 is the second label value.

2. The music player system according to claim 1, wherein the first label value is a tempo label value provided for each of the music files by the identifying and sorting unit and the labeling unit according to the tempo of each of the music files, and the second label value is a time label value provided for each of the music files by the identifying and sorting unit and the labeling unit according to the issue date of each of the music files.

3. The music player system according to claim 1, wherein the first label value is a tempo label value provided for each of music files by the identifying and sorting unit and the labeling unit according to the tempo of each of the music files, and the second label value is a pitch label value provided for each of the music files by the identifying and sorting unit and the labeling unit according to the pitch of each of the music files.

4. The music player system according to claim 1, wherein the first label value is a pitch label value provided for each of the music files by the identifying and sorting unit and the labeling unit according to the pitch of each of the music files, and the second label value is a time label value provided for each of the music files by the identifying and sorting unit and the labeling unit according to the issue date of each of the music files.

5. The music player system according to claim 1, wherein when the command received is a one-finger scrolling command determined by a finger sliding on the touch panel, the coordinate of a starting point of the sliding on the touch panel, and the coordinate of a final point of the sliding on the touch panel, the execution unit calculates the relational value (P) for each of the music files by an equation as follows:
(X3−C1)²+(Y3−C2)²=P (2)
wherein X3 is the coordinate of the starting point on the X-axis of the coordinate system, and Y3 is the coordinate of the starting point on the Y-axis of the coordinate system.

6. The music player system according to claim 1, wherein the music files on the playlist are played in random.

7. The music player system according to claim 1, wherein the music files on the playlist are played in a sequence of the relational values (P), from the smallest to the largest.

8. The music player system according to claim 1, wherein when the command received is a threshold value-changing command determined by two fingers sliding on the touch panel, the coordinates of starting points of the fingers on the touch panel and the coordinates of final points of the fingers on the touch panel, the execution unit changes the threshold value (F).

9. The music player system according to claim 8, wherein the execution unit reduces the threshold value (F) if the distance between the starting points of the fingers is longer than the distance between the final points of the fingers, and increases the threshold value (F) if the distance between the starting points of the fingers is shorter than the distance between the final points of the fingers.

10. The music player system according to claim 1, wherein when the command received is a list-changing command determined by double clicks on the touch panel, the execution unit stops playing the music files and deletes the playlist.

11. The music player system according to claim 1, wherein when the command received is a locking command given by a long touch on the touch panel, the execution unit repeats the music file that is playing for at least once according to the locking command.

12. The music player system according to claim 11, wherein when the command received is an unlocking command given by another long touch on the touch panel after the locking command, the execution unit cancels the locking command according to the unlocking command.

13. The music player system according to claim 2, wherein the operation interface comprises a tempo axis and a time axis perpendicularly intersecting the tempo axis at a common origin, two senses of direction of the tempo axis respectively represent slow tempo and quick tempo, and two senses of direction of the time axis respectively repesent early issue date and late issue date.

14. The music player system according to claim 3, wherein the operation interface comprises a tempo axis and a pitch axis perpendicularly intersecting the tempo axis at a common origin, two senses of direction of the tempo axis respectively represent slow tempo and quick tempo, and two senses of direction of the pitch axis respectively represent high pitch and low pitch.

15. The music player system according to claim 4, wherein the operation interface comprises a pitch axis and a time axis perpendicularly intersecting the time axis, two senses of direction of the pitch axis respectively represent high pitch and low pitch, and two senses of direction of the time axis respectively represent early issue date and late issue date.

16. A music-playing method for use in a mobile device that includes a touch panel, the music-playing method comprising the steps of:
a preceding process comprising the steps of:
reading all of the music files and their title labels in the music data folder of the storage medium of the smart mobile device;
identifying, sorting and sequencing all of the music files; and
providing each of the music files with a first label value (C1) and a second label value (C2) and writing the first label value (C1) and the second label value (C2) in the title label of each of the music files; and
a playing process.

17. The music-playing method according to claim 16, wherein the playing process comprises the steps of:
obtaining the coordinate (X, Y) of a single click when the user operates the touch panel;
providing each of the music files with a relational value (P) according to an equation as follows and writing the relational value (P) in the title label of each of the music files:
(X−C1)²+(Y−C2)²=P (3)
wherein X is the coordinate of the single click on an X-axis of a coordinate system, Y is the coordinate of the single click on a Y-axis of the coordinate system, C1 is the first label value, and C2 is the second label value;
comparing the relational value P with a threshold value F and including a music file in a playlist if the relational value P thereof is smaller than or equal to the threshold value F;
initiating a player of the smart mobile device to play the music files in random or in a sequence of the relational values P on the playlist, from the smallest to the largest.

18. The music-playing method according to claim 16, wherein the first label value is a tempo label value provided for each of the music files by the identifying and sorting unit and the labeling unit according to the tempo of each of the music files, and the second label value is a time label value provided for each of the music files by the identifying and sorting unit and the labeling unit according to the issue date of each of the music files.

19. The music player system according to claim 16, wherein the first label value is a tempo label value provided for each of music files by the identifying and sorting unit and the labeling unit according to the tempo of each of the music files, and the second label value is a pitch label value provided for each of the music files by the identifying and sorting unit and the labeling unit according to the pitch of each of the music files.

20. The music player system according to claim 16, wherein the first label value is a pitch label value provided for each of the music files by the identifying and sorting unit and the labeling unit according to the pitch of each of the music files, and the second label value is a time label value provided for each of the music files by the identifying and sorting unit and the labeling unit according to the issue date of each of the music files.

21. The music-playing method according to claim 16, wherein the playing process comprises the steps of:
obtaining the coordinate (X1, Y1) of a starting point and the coordinate (X2, Y2) of a final point of a one-finger scrolling after the user operates the touch panel to give a scrolling command;
calculating the coordinate (X3, Y3) of a vector by an equation as follows:
(X3, Y3)=(X2−X1, Y2−Y1) (4)
calculating a relational value (P) for each of the music files according to an equation as follows:
P=(X3−C1)²+(Y3−C2)² (5)
comparing the relational value (P) with a threshold value (F) and including a music file in a playlist if the relational value (P) is smaller than or equal to the threshold value (F);
initiating the player of the smart mobile device to play the music files in random or in a sequence of the relational values (P) on the playlist, from the smallest to the largest.

22. The music-playing method according to claim 17, wherein the threshold value is changeable by a process comprising the steps of:
obtaining a distance between two staring points and a distance between two final points after the user operates the touch panel to conduct a two-finger scrolling; and
comparing the distance between the starting points with the distance between the final points, reducing the relational value (F) if the distance between the starting points is longer than the distance between the final points, and increasing the relational value (F) if the distance between the starting points is shorter than the distance between the final points.

23. The music-playing method according ton claim 17, wherein the first label value is a tempo label value provided for each of the music files by the identifying and sorting unit and the labeling unit according to the tempo of each of the music files, and the second label value is a time label value provided for each of the music files by the identifying and sorting unit and the labeling unit according to the issue date of each of the music files.

24. The music player system according to claim 17, wherein the first label value is a tempo label value provided for each of music files by the identifying and sorting unit and the labeling unit according to the tempo of each of the music files, and the second label value is a pitch label value provided for each of the music files by the identifying and sorting unit and the labeling unit according to the pitch of each of the music files.

25. The music player system according to claim 17, wherein the first label value is a pitch label value provided for each of the music files by the identifying and sorting unit and the labeling unit according to the pitch of each of the music files, and the second label value is a time label value provided for each of the music files by the identifying and sorting unit and the labeling unit according to the issue date of each of the music files.
